(19) United States
(12) Patent Application Publication
(10) Pub. No.: US 2007/0248392 A1
(43) Pub. Date: Oct. 25, 2007

(54) PRINTING CONTROL APPARATUS AND IMAGE PICKUP APPARATUS

(75) Inventor: Toru TAKASHIMA, Osaka (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Osaka (JP)

(21) Appl. No.: 11/738,829

(22) Filed: Apr. 23, 2007

(30) Foreign Application Priority Data
Apr. 25, 2006 (JP) JP2006-120243

(51) Int. Cl. B41J 5/30

(52) U.S. Cl. 400/62

(57) ABSTRACT

A printing control apparatus of the present invention includes a monitor that displays predetermined time segments in a list, a microcomputer that classifies image data recorded in a memory for each of the predetermined time segments, and an operating portion that receives a predetermined operation and transmits a content of the received operation to the microcomputer, wherein when the operating portion receives a predetermined operation for printing including an operation for specifying one or a plurality of time segments among the predetermined time segments displayed in a list, the microcomputer gives a printing instruction with respect to a whole or a part of the image data classified in a time segment specified by the predetermined operation, or can perform setting with respect to the printing. According to this configuration, the operability can be enhanced in a calendar display and printing instruction/setting.

### BACKGROUND OF THE INVENTION

1. Field of the Invention

The present invention relates to an image pickup apparatus with a monitor such as a liquid crystal display panel mounted thereon. In particular, the present invention relates to an image pickup apparatus capable of displaying a calendar on a screen of a monitor and displaying an image in a thumbnail in each date section of the calendar. More specifically, the present invention relates to a printing control apparatus capable of displaying, in each date section of a calendar displayed on a monitor, an image photographed on that date in a thumbnail and printing the image from a thumbnail display state. Furthermore, the present invention relates to an image pickup apparatus equipped with such a printing control apparatus.

2. Description of Related Art

A monitor capable of displaying an electrical image as well as a viewfinder enabling an optical image to be identified visually are mounted in a conventional digital camera. For example, JP 2004-274500 A discloses an image pickup apparatus having a configuration of displaying an image (so-called “through image”) imaged currently by an image pickup element, displaying an image enlarged or reduced by zooming, and displaying a number of menus such as album calibration.

Compared with a conventional film camera, a digital camera is capable of storing a number of image data in an information medium. That is, the digital camera is configured so as to store image data generated by photographing in an information medium such as a memory card. Therefore, as the capacity of an information medium increases, a larger number of image data can be stored in the information medium. Thus, it is important to arrange images stored in the information medium so as to make it easy to see them. JP 2004-260710 A discloses a configuration of displaying a calendar on a monitor and displaying an image with a photographed date associated therewith.

Furthermore, since the digital camera handles an image in the form of electronic data, the image can be printed easily when the digital camera is connected to a printer. As the printing precision of the printer is enhanced, an image of electronic data can be printed in a comparable manner to that of an image on ordinary photographic paper. JP 10(1998)-108005 A discloses a configuration capable of printing an image of high quality.

Hereinafter, a technique of printing an image based on image data associated with a photographed date will be described briefly.

FIG. 24 shows a state in which an image associated with a calendar (see JP 2004-260710 A) is displayed on a monitor 12. In FIG. 24, information on a photographed date is read from a memory storing image data, and based on the information on the photographed date, an image is displayed in a frame corresponding to the date of a calendar. When the date associated with the image data is designated with a cursor 143 in the calendar, the image based on the image data can be displayed. Furthermore, in the case where a plurality of images are associated with the designated date, a multi-display is performed. By designating an arbitrary thumbnail image with a cursor or the like in multi-displayed thumbnail images, the designated image can be displayed on the monitor 12.

FIG. 25 shows a state in which a camera 10 and a printer 9 are connected to each other via a cable 11. In FIG. 25, although the printer 9 is drawn in a size smaller than that of the camera 10, the outer shape of the printer 9 actually is larger than that of the camera 10. When printing is performed, multiple images shown in FIG. 26 are displayed on a monitor of the camera 10, and an image desired to be printed is selected. Next, a printing instruction is entered by operating the camera 10, whereby the image data is output to the printer 9 via the cable 11.

FIG. 26 shows the case where 9 thumbnail images 8 are displayed on a screen of the monitor 12.

In the above-mentioned configuration, the function of attaching an image to a calendar displayed on the monitor 12 of the camera 10 and the function of transferring image data from the camera 10 to the printer 9 to print an image do not directly cooperate with each other. That is, the display of a calendar and the printing of an image are prepared in separate modes. Therefore, an instruction for printing an image specified from the calendar display cannot be given immediately, which makes it necessary to perform a complicated operation. Specifically, when an image is printed in a state where the image is being displayed in a calendar, it is necessary to perform a procedure of switching the mode of the camera 10 from a calendar display mode to a printing mode, selecting an image desired to be printed, and giving a printing instruction.

### SUMMARY OF THE INVENTION

Therefore, with the foregoing in mind, it is an object of the present invention to provide a printing control apparatus capable of managing images easily by displaying the images and a calendar display such that they are associated with each other, and giving a printing instruction in a calendar display state easily. It is another object of the present invention to provide an image pickup apparatus equipped with the printing control apparatus.

A printing control apparatus of the present invention reads electronic image information recorded in a storage and gives a printing instruction with respect to a whole or a part of the read electronic image information. The apparatus includes: a display that displays predetermined time segments in a list; a controller that classifies the electronic image information recorded in the storage for each of the predetermined time segments; and an operating portion that receives a predetermined operation and transmits a content of the received operation to the controller. When the operating portion receives a predetermined operation for printing including an operation for specifying one or a plurality of time segments among the predetermined time segments displayed in a list, the controller controls so as to give a printing instruction with respect to a whole or a part of the electronic image information classified in a time segment specified by the predetermined operation or perform setting with respect to the printing.

An image pickup apparatus of the present invention reads electronic image information recorded in a storage and gives a printing instruction with respect to a whole or a part of the read electronic image information. The apparatus includes: a display that displays predetermined time segments in a list; a controller that classifies the electronic image information recorded in the storage for each of the predetermined time segments; and an operating portion that receives a predetermined operation and transmits a content of the received operation to the controller. When the operating portion receives a predetermined operation for printing including an operation for specifying one or a plurality of time segments among the predetermined time segments displayed in a list, the controller controls so as to give a printing instruction with respect to a whole or a part of the electronic image information classified in a time segment specified by the predetermined operation or perform setting with respect to the printing.

### BRIEF DESCRIPTION OF THE DRAWINGS

FIG. 1 is a plan view showing a rear surface of a camera in Embodiment 1.

FIG. 2 is a block diagram showing an internal configuration of the camera in Embodiment 1.

FIG. 3 is a schematic diagram showing a configuration in which image data is managed in a medium in which the image data is to be recorded.

FIG. 4 is a flowchart showing a flow of creating a file management table.

FIG. 5 is a schematic diagram showing a configuration of the file management table.

FIG. 6 is a flowchart showing a main flow of printing from a thumbnail calendar display.

FIG. 7 is a flowchart showing a flow in the case of being operated in the main flow.

FIG. 8 is a schematic diagram showing a configuration of a calendar display table.

FIG. 9 is flowchart showing a flow of a preprocessing part of the main flow.

FIG. 10 is a flowchart showing a flow of performing a thumbnail calendar display.

FIG. 11 is a schematic view illustrating a date frame of the thumbnail calendar display.

FIG. 12 is a schematic view showing the detail of an operating portion.

FIG. 13 is a flowchart showing a flow of processing of the operating portion.

FIG. 14 is a schematic view of a screen for prompting a user to give a printing instruction.

FIG. 15 is a flowchart showing a flow of printing processing.

FIG. 16 is a schematic view of a screen to be displayed in the case of allowing a plurality of dates to be designated.

FIG. 17 is a schematic view of a screen for inquiring about an output destination.

FIG. 18 is a flowchart showing a flow of printing processing.

FIG. 19A is a schematic diagram showing a configuration of a CMDT.

FIG. 19B is a schematic diagram showing a configuration of the CMDT.

FIG. 20 is a schematic view showing a screen for displaying data to be output.

FIG. 21 is a schematic view showing a screen for deleting data to be output.

FIG. 22 is a flowchart showing a flow of creating the CMDT.

FIG. 23 is a flowchart showing a flow of deleting a designated date.

FIG. 24 is a schematic view showing a screen of a thumbnail calendar display.

FIG. 25 is a schematic view showing a state in which a camera and a printer are connected to each other.

FIG. 26 is a schematic view showing a multi-screen display.

### DETAILED DESCRIPTION OF THE INVENTION

### Embodiment 1

### (1. Basic Configuration and Operation of an Image Pickup Apparatus)

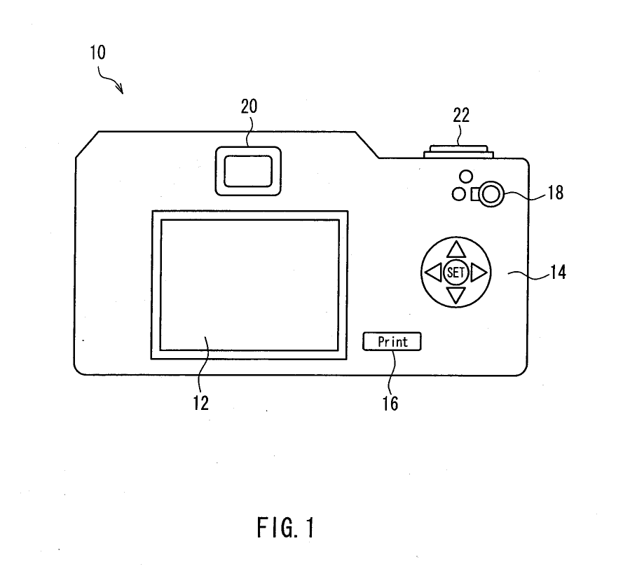

FIG. 1 is a rear view of a camera. Although a lens is placed on a front surface side of a camera 10, the lens is not shown. The camera 10 includes a monitor 12, an operating portion 14, a print button 16, a power switch 18, a viewfinder 20, and a release button 22.

The monitor 12 (display portion) can display an image stored in a memory card, an image (through image) that is being imaged by an image pickup element, a menu image, or the like. The monitor 12 can be composed of a liquid crystal panel, an organic EL panel, an inorganic EL panel, or the like. The monitor 12 also can be composed of a touch-panel type display panel, which enables the operating portion 14 to be omitted, resulting in the reduction in cost. Furthermore, according to the touch-panel type display panel, a screen of the monitor 12 is operated directly, so that the operability can be enhanced.

The operating portion 14 is composed of a cursor key capable of being operated in up-and-down and right-and-left directions, and a pressure button placed at the center of the cursor key. The operating portion 14 receives a user's instruction in various modes, and gives the received instruction to the camera 10. The operating portion 14 is not limited to a switch in which a cursor key and a pressure button are integrated, and may be composed of a lever type switch capable of being operated in up-and-down and right-and-left directions, a rotary switch, or the like.

The print button 16 activates an operation of outputting image data recorded in a memory card attached to the camera 10 to the printer 9 (see FIG. 25). In the present embodiment, although the print button 16 is realized with hardware, the print button 16 may be realized with software. For example, a character of a “printing instruction” may be displayed in a menu image to be displayed on the monitor 12, and the character is selected by operating the operating portion 14, whereby the image data is output to the printer 9.

The power switch 18 switches on/off a power supply of the camera 10.

An optical image incident through the lens (not shown) is guided to the viewfinder 20, and a user can identify the optical image visually by peering through the viewfinder 20. The viewfinder 20 may be composed of an electronic viewfinder equipped with a small liquid crystal monitor therein, instead of the optical viewfinder as described above.

The release button 22 is a switch for capturing an image imaged by the image pickup element.

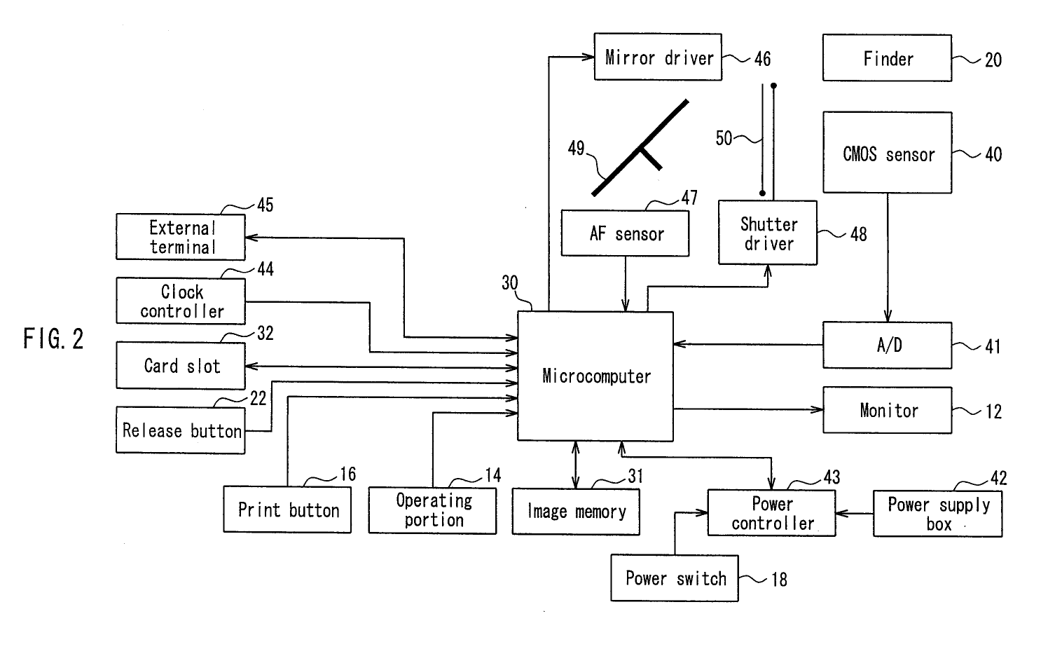

FIG. 2 shows an internal configuration of the camera 10 of the present invention. As shown in FIG. 2, the camera 10 includes the monitor 12, the operating portion 14, the print button 16, the power switch 18, the viewfinder 20, the release button 22, a microcomputer 30 (control portion), an image memory 31, a card slot 32, a CMOS sensor 40 (image pickup element), an analog/digital converter 41 (hereinafter, referred to as an ADC), a battery box 42, a power controller 43, a clock controller 44, an external terminal 45, a mirror driver 46, an AF sensor 47 (AF: Auto Focus), a shutter driver 48, a mirror 49, and a shutter 50.

In FIG. 2, the operation of the camera 10 mainly is controlled by the microcomputer 30. For example, the operation of the monitor 12 shown in FIG. 1 is controlled by the microcomputer 30. Furthermore, control information generated when the operating portion 14, the print button 16, and the power switch 18 are operated is transmitted to the microcomputer 30. Furthermore, although the camera 10 is composed of a single-lens reflex digital camera in the present embodiment, the camera 10 is not limited thereto.

Next, the photographing operation of the camera 10 will be described. An optical image incident through the lens (not shown) is reflected by the mirror 49 to be guided to the viewfinder 20. The user can identify the optical image visually by peering through the viewfinder 20. Furthermore, the optical image transmitted through the mirror 49 is guided to the AF sensor 47. Control data output from the AF sensor 47 is input to the microcomputer 30. The microcomputer 30 drives a focus lens (not shown) based on the input control data, thereby performing autofocusing.

When the user operates the release button 22, the microcomputer 30 controls the mirror driver 46 to retract the mirror 49 from an incident optical axis. Furthermore, the microcomputer 30 controls the shutter driver 48 to open the shutter 50. Consequently, the optical image incident through the lens is guided to an image pickup plane of the CMOS sensor 40. The CMOS sensor 40 converts the incident optical image into an electric signal and outputs it. The electric signal output from the CMOS sensor 40 is converted into digital data in the ADC 41. The digital data output from the ADC 41 will be referred to as “pixel data”. The pixel data output from the ADC 41 is input to the microcomputer 30. The microcomputer 30 subjects the input image data to image processing, and accumulates the resultant image data in the image memory 31. The CMOS sensor 40 is an example of the image pickup element.

On the other hand, the clock controller 44 can measure an elapsed period from a reference date and time, and output the measurement result as information on a current date (year, month, day) and time. When the release button 22 is operated, the information on a current date and time output from the clock controller 44 is stored in a memory in the microcomputer 30. The current date and time is defined as a “photographed date and time”. Furthermore, information on photographing conditions such as an aperture amount and a shutter speed is stored in the memory in the microcomputer 30.

The microcomputer 30 (control portion) can record pixel data stored in the image memory 31 and attached data such as photographing conditions and a photographed date and time in the memory card attached to the card slot 32. The pixel data and attached data are defined as “image data” collectively. Electronic image information, and image data or pixel data are used interchangeably.

Furthermore, when the user operates the operating portion 14, the microcomputer 30 can read pixel data stored in the image memory 31 or in the memory card attached to the card slot 32 and allow an image based on the pixel data to be displayed on the monitor 12. Consequently, the user can identify the photographed image visually on the monitor 12.

Furthermore, the external terminal 45 can be connected to the cable 11 (see FIG. 25) connected an external appliance such as the printer 9 (see FIG. 25). When the external terminal 45 is connected to the external appliance through a signal line such as the cable 11, and the operating portion 14 receives an external output instruction by the user, the microcomputer 30 can send the image data to the external appliance through the external terminal 45 and the cable 11. The external terminal 45 may be configured so as to perform data communication through a radio wave, light, a voice, or the like, instead of being configured so as to be connected to the cable 11 as in a connector or a terminal.

Furthermore, a power is supplied from a battery attached to the battery box 42 to each portion in the camera 10. The power controller 43 controls the amount of a power supplied to each portion so as to handle the case where a large current is required temporarily.

### (2. Configuration of a Thumbnail Calendar)

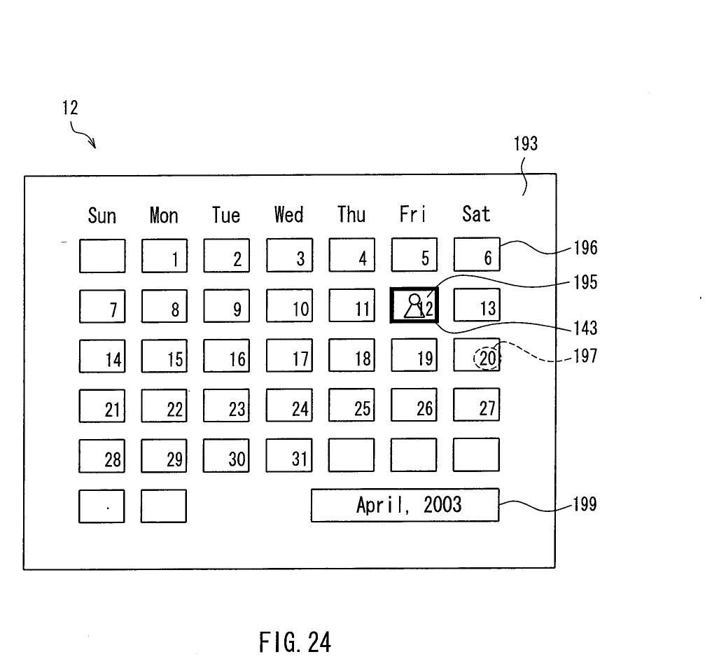

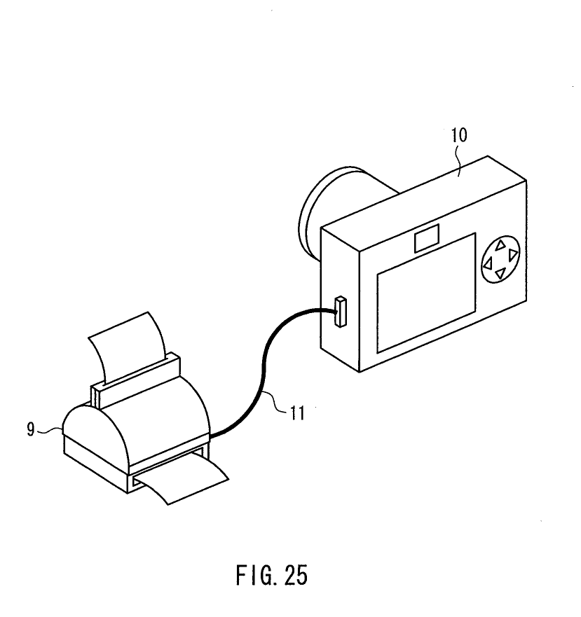

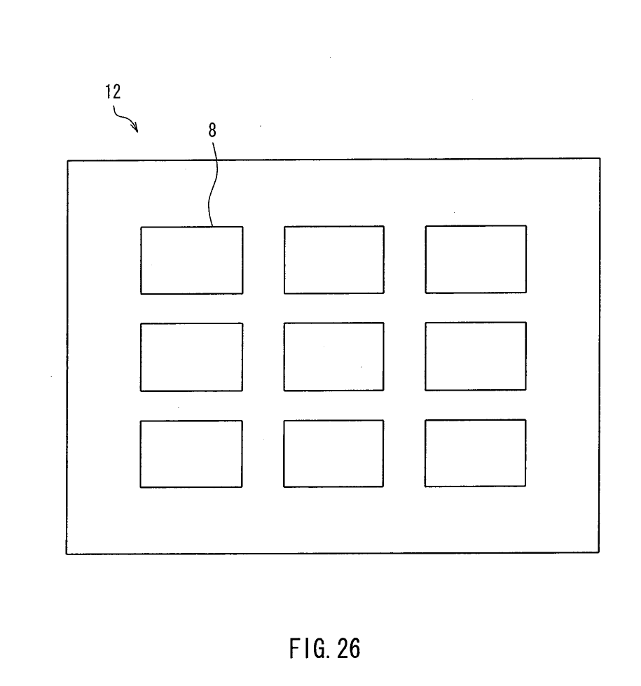

The camera 10 of the present embodiment can perform various software processing and display control with the monitor 12, the microcomputer 30, the operating portion 14, and the software stored in the memory in the microcomputer 30, in addition to the above-mentioned photographing operation. As one embodiment of the display control, there is a thumbnail calendar display (see FIG. 24).

Furthermore, the camera 10 of the present embodiment has a function capable of sending image data to the printer 9 to give a printing instruction by performing a predetermined operation when the camera 10 is connected to the printer 9 through the cable 11 as shown in FIG. 25, and a thumbnail calendar is being displayed on the monitor 12. In order to realize this function, it is necessary that, first, the thumbnail calendar shown in FIG. 24 is displayed on the monitor 12, an arbitrary date (date associated with the image data) is designated on the displayed thumbnail calendar, and the image data is output. In the following description, the date designated by the user on the thumbnail calendar will be referred to as a “designated date”.

The image data is stored in a memory card attached to the card slot 32. The image data stored in the memory card is managed in a file form, based on a predetermined directory structure.

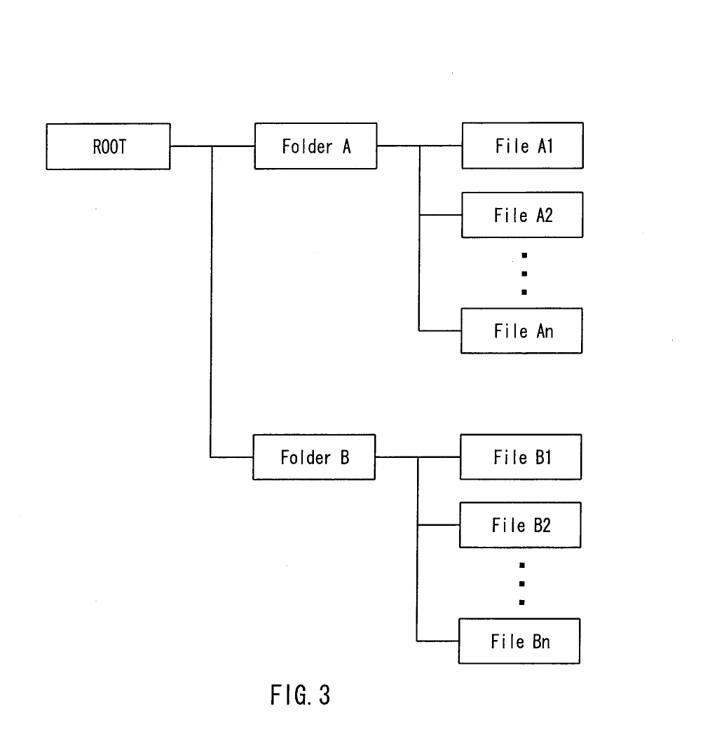

FIG. 3 shows a directory structure managing image data. A directory has an origin called a “ROOT”. There is a “folder” under the “ROOT”. A plurality of files can be stored in the folder. In FIG. 3, for example, a folder A (“A” is a folder number) stores a file A1 to a file An (“A1” and the like denote file numbers).

Each file contains image data corresponding to one image. More specifically, the file contains pixel data and attached data. In other words, each image data can be specified by designating a folder number and a file number. In the following description, a combination of a folder number and a file number will be referred to as a “file path”. The file path is called a “smaller file path” as the folder number is smaller or the file number is smaller in the case where the folder number is the same. In the present embodiment, a file recorded earlier in terms of time is provided with a smaller file path, and a file recorded later in terms of time is provided with a larger file path. A file recorded later in terms of time may be provided with a smaller file path.

In order to display a thumbnail calendar on the monitor 12, it is necessary to specify a folder number and a file number of image data stored in a memory card, check a recorded date and time of each file, and specify a file with the smallest file path among the files recorded on the same day. An image to be displayed on the thumbnail calendar is not limited to an image contained in a file with the smallest file path, and may be an image contained in a film with the largest file path or an image determined based on other conditions.

Furthermore, in the present embodiment, in order to display a thumbnail calendar, a file management table (described as an “FMT” in the figures) and a calendar display table (described as a “CDT” in the figure) are created.

### (2-1. Configuration of a File Management Table)

The file management table indicates the presence/absence of a folder number and a file number of an image recorded in a memory card. The file management table is created immediately after the power switch 18 is operated to turn on the power supply of the camera 10.

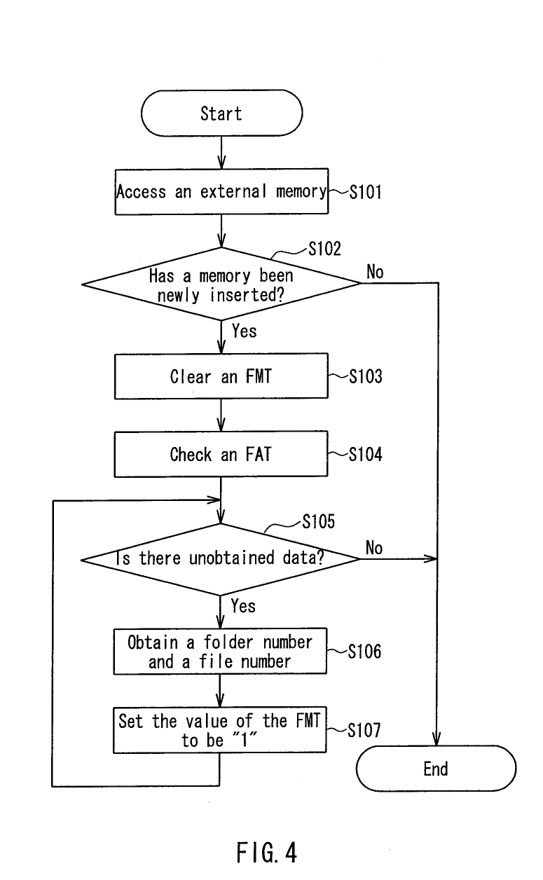

FIG. 4 shows a flow of creating the file management table. The flow shown in FIG. 4 starts during an initialization operation after the power switch 18 is operated to turn on the power supply of the camera 10.

First, the microcomputer 30 accesses a memory card attached to the card slot 32 (S101), and checks whether or not the memory card attached to the card slot 32 is a memory card that has been newly attached to the card slot 32 (S102). In the case where the memory card is not the one that has been newly attached, the flow is completed. The reason for completing the flow is that a file management table already is present.

On the other hand, when the memory card attached to the card slot 32 is the one that has been newly attached, initialization processing is performed so as to create a file management table newly. In the initialization processing, a file management table is reset (S103). To “reset” refers to an operation of setting all the values in the table to be zero.

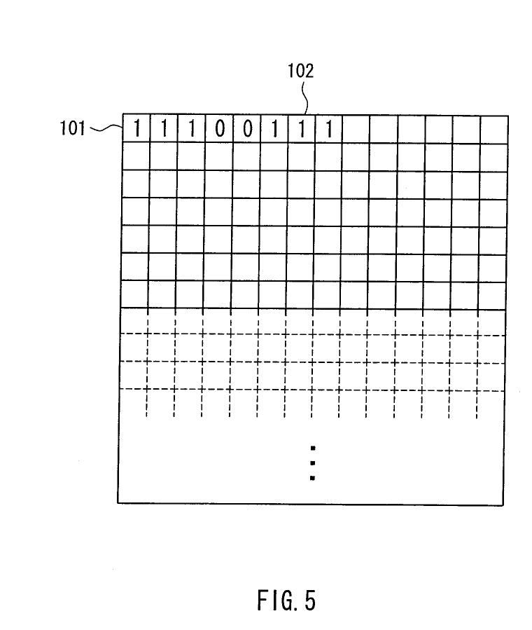

FIG. 5 schematically shows the data structure of a file management table. The file management table is stored in a non-volatile memory placed in the microcomputer 30. The content of the file management table is as follows: one bit of information is prepared by the number of files that can be present. The number of files that can be stored in one folder is determined previously. Therefore, if it is checked “how-manieth” bit from the first bit image data corresponds to in the file management table, a folder number and a file number (i.e., a file path) at which the image data is present can be specified. In FIG. 5, a bit 101 is the first bit in the file management table, in which information representing whether or not image data corresponding to the file A1 in the folder A is present is written. The value of a bit being “1” indicates that the image data corresponding to the file path thereof is present. Information on the files A2, A3, . . . An is written in the order (right direction in FIG. 5) from the bit 101. For example, in a seventh bit 102 from the first bit, information on the file A7 in the folder A is written. As shown in FIG. 5, the value of the bit 102 is “1”. This indicates that there is image data corresponding to the file path thereof. As described above, the file management table is configured.

Returning to FIG. 4, the microcomputer 30 checks an FAT (File allocation table) of the memory card (S104). In the FAT, information on a folder number, a file number, and a recorded date are recorded for each image data.

Next, the microcomputer 30 obtains information on the FAT one by one. The information to be obtained is a folder number and a file number (S106).

Next, the microcomputer 30 sets the value of a bit in the file management table corresponding to the obtained folder number and file number to be “1” (S107). Then, the flow returns to Step S105.

In Step S105, in the case where unobtained data is present in the FAT, the processing in Steps S106 and S107 are repeated in the same way as the above until the unobtained data is not present. When all the FATs are obtained and checked, the flow is completed.

A calendar display table is created after an instruction for a thumbnail calendar display is entered. Before the calendar display table is described, the procedure leading to the thumbnail calendar display will be described.

### (2-2. Operation of a Thumbnail Calendar Display Mode)

The thumbnail calendar display is performed based on one software processing of the camera 10. Specifically, when the operating portion 14 receives an operation for shifting to a thumbnail calendar display mode, the microcomputer 30 controls each portion to allow it to shift to a thumbnail calendar display mode. In the present embodiment, each portion is controlled so as to shift to a thumbnail calendar display mode by the operation of the operating portion 14. However, each portion may be allowed to shift to a thumbnail calendar display mode by providing the camera 10 with an operating portion dedicated to a mode shift and operating the operating portion.

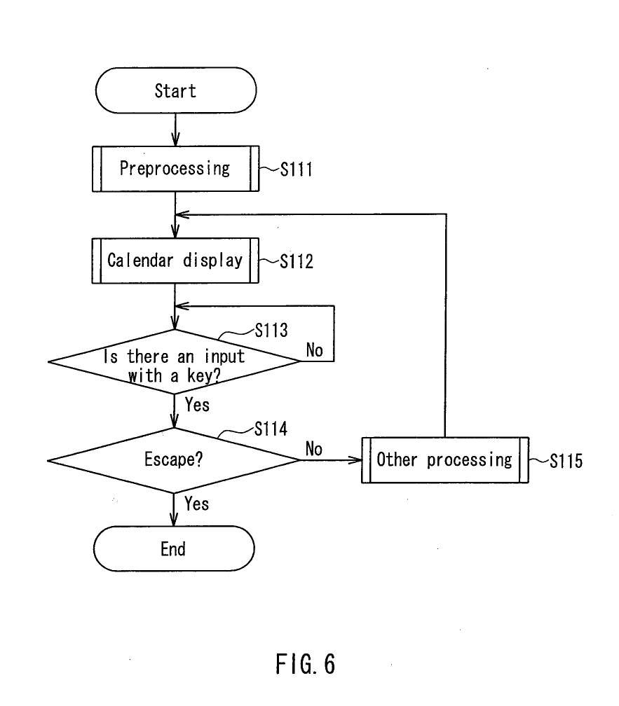

FIG. 6 shows a flow of the thumbnail calendar display. When the operating portion 14 receives an operation of a thumbnail calendar display by a user, a flow shown in FIG. 6 starts.

First, the microcomputer 30 performs preprocessing (S111). The microcomputer 30 creates a calendar display table in the preprocessing. Next, the microcomputer 30 controls so as to create a thumbnail calendar and display the thumbnail calendar on the monitor 12 (S112). Next, the microcomputer 30 stands by until the operating portion 14 is operated (S113). When an operation of escaping from the thumbnail calendar display mode is performed while the thumbnail calendar is being displayed on the monitor 12, the microcomputer 30 completes the thumbnail calendar display mode (S114). On the other hand, when an operation other than the escape is performed while the thumbnail calendar is being displayed on the monitor 12, the microcomputer 30 performs processing in accordance with an operated key (S115). The key capable of giving an instruction for the escape may be allocated to any key in the operating portion 14, an escape button may be placed on the camera 10, or another operation key such as a menu button also may be used for the escape.

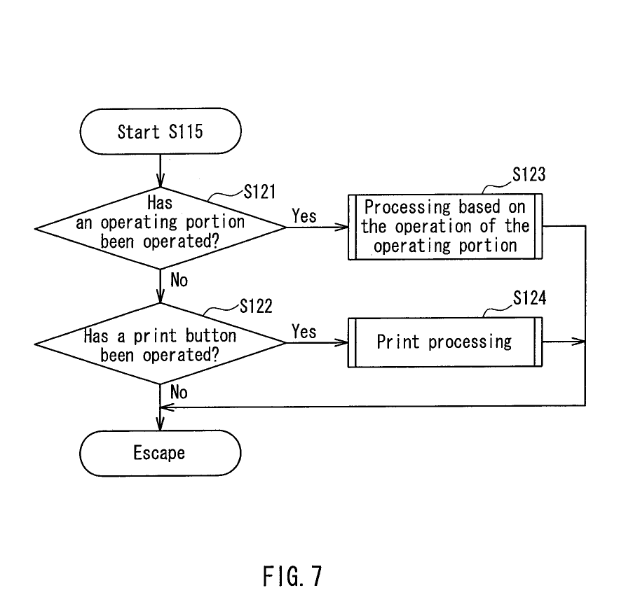

FIG. 7 shows the contents of the processing in Step S115 in FIG. 6. As shown in FIG. 7, when the processing in Step S15 in FIG. 6 is started, it is determined whether the operating portion 14 has been operated (S121) or the print button 16 has been operated (S122). In the case where the operating portion 14 has been operated, the function allocated to each key of the operating portion 14 is executed (S123). Furthermore, in the case where the print button 16 has been operated, print processing is executed (S124). After either the processing in S123 or the processing in S124 is performed, the flow returns to the state of the thumbnail calendar display (Step S112 in FIG. 6).

### (2-3. Configuration of a Calendar Display Table)

A calendar display table is created in the preprocessing (S111) shown in FIG. 6. Furthermore, the calendar display table is created so as to display a thumbnail calendar.

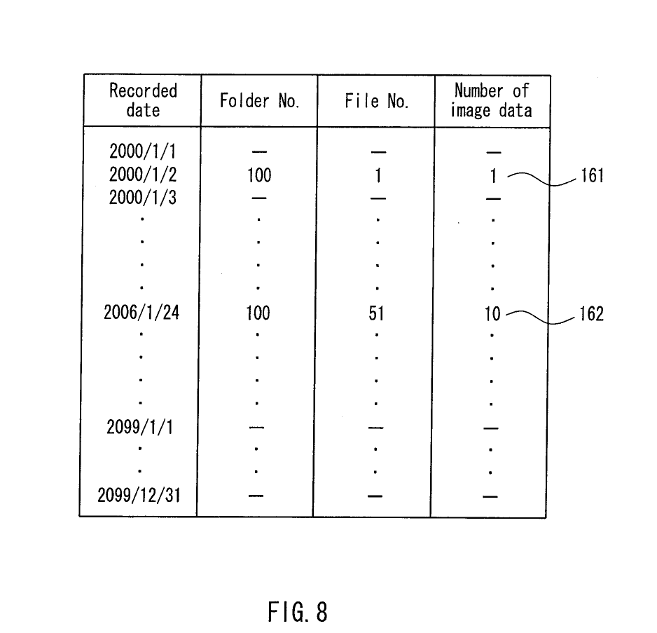

FIG. 8 shows the configuration of a calendar display table. Although the calendar display table is created by the microcomputer 30 and stored in a memory in the microcomputer 30, the calendar display table may be stored in the image memory 31 or a memory card attached to the card slot 32. The calendar display table previously is assigned data on dates in a predetermined period. FIG. 8 is assigned dates from Jan. 1, 2000 to Dec. 31, 2099.

In the case where there is image data having a recorded date matched with a date on a calendar, information on the image data is associated with the date. The information to be associated includes a folder number and a file number of the image data, and the number of image data recorded on that date. For example, an entry 161 in FIG. 8 shows that the number of image data with a recorded date of Jan. 2, 2000 is one. The entry 161 also shows that the image data is stored in an address with a folder number “100” and a file number “1” in the memory card. Furthermore, an entry 162 in FIG. 8 shows that the number of image data with a recorded date of Jan. 24, 2006 is 10. The entry 162 also shows that representative image data (image data with the smallest file path in the present embodiment) among 10 image data is stored in an address with a folder number “100” and a file number “51”. The representative image data is image data on an image to be displayed on a thumbnail calendar when the thumbnail calendar is displayed. Although an image based on image data with the smallest file path among 10 image data recorded on that day (Jan. 24, 2006 in the table shown in FIG. 8) is displayed on the thumbnail calendar in the present embodiment, an image based on another image data may be displayed.

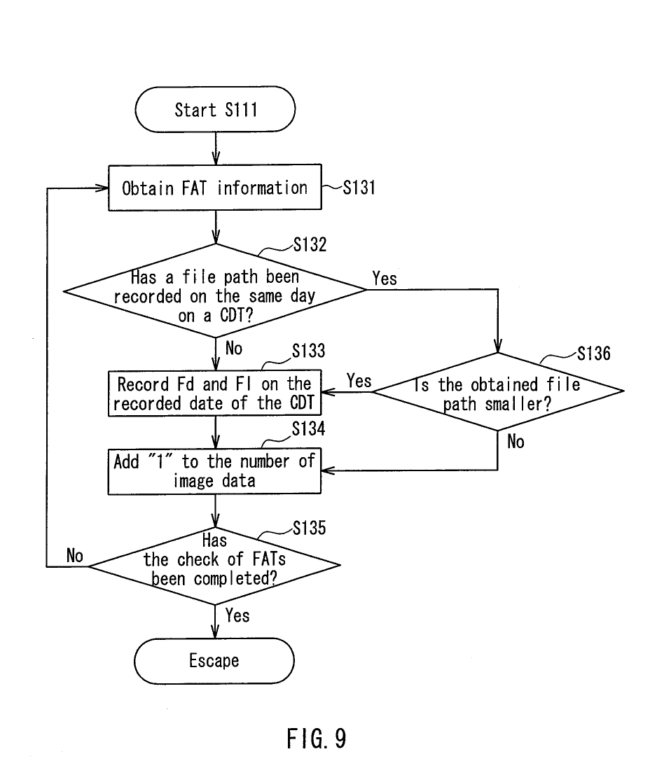

FIG. 9 shows a flow of creating a calendar display table. The processing shown in FIG. 9 is performed in the preprocessing (S111) shown in FIG. 6, and started automatically by the microcomputer 30 of the camera 10.

First, the microcomputer 30 obtains an FAT from a memory card (S131). The data to be obtained is information on a file path and a date (recorded date) on which an image has been recorded in the memory card. In the case where a file path already has been recorded in a portion corresponding to the currently obtained recorded date in the calendar display table (Yes in S132), the file path that already has been recorded is compared with the currently obtained file path (S136). If the currently obtained file path is smaller (Yes in S136), the microcomputer 30 records the currently obtained folder number (Fd) and file number (F1) in the calendar display table (S133). More specifically, the folder number and file number recorded in the calendar display table are rewritten to the currently obtained folder number and file number.

Then, the microcomputer 30 adds “1” to the number of image data in the calendar display table (S134). On the other hand, if the file path that already has been recorded in the calendar display table is larger (No in S136), the microcomputer 30 adds “1” to the number of image data without rewriting a folder number and a file number. Consequently, a file path with the smallest file path always is recorded in the calendar display table.

Next, the microcomputer 30 determines whether or not the check of the FATs has been completed (S135). If there is an unchecked FAT, the flow returns to Step S131. If the check of the FATs to be checked has been completed, the flow shown in FIG. 9 is completed. The calendar display table shown in FIG. 8 is created as described above.

In the above description, although the calendar display table is created based on FAT information, a file is specified based on obtained FAT information, information on a photographed data stored in the specified file is read, and the read photographed data is associated with a calendar, whereby a calendar display table can be created. More specifically, as the FAT information, generally, information on a date and time at which a file has been recorded in a memory card is recorded, and information on a date and time at which photographing has been performed is not recorded. For example, it is assumed that a personal computer is operated to record image data, which is recorded in a hard disk drive placed in the personal computer, in a memory card. At this time, date and time information to be recorded in the FAT is not a photographed date and time but a recorded date and time with respect to the memory card. Thus, an image photographed two months ago may be displayed as an image of yesterday in the thumbnail calendar display. Thus, if a photographed date and time (at least a photographed date) is read from each file (i.e., image data), and a file path is recorded with the date information in the calendar display table associated therewith, a thumbnail image can be displayed on the photographed date in the calendar.

### (2-4. Method for Displaying a Thumbnail Calendar)

When the calendar display table is completed, a thumbnail calendar can be displayed.

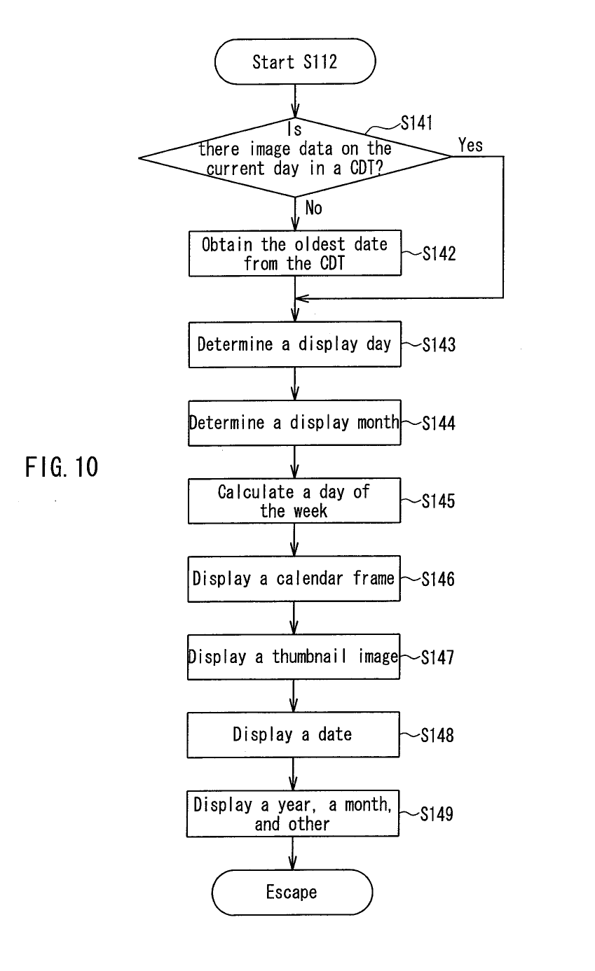

FIG. 10 shows a flow of displaying a thumbnail calendar. The processing shown in FIG. 10 is performed under the control of the microcomputer 30. The thumbnail calendar is displayed on the monitor 12. Furthermore, when the processing shifts to Step 112 in FIG. 6, the flow shown in FIG. 10 is started automatically by the microcomputer 30.

First, the microcomputer 30 checks a calendar display table, and searches for image data with a recorded date matched with current date and time information obtained from the clock controller 44 by the microcomputer 30 (S141). If there is image data with a recorded date matched with the current date and time information in the calendar display table, that date (today) is determined as a display day (S143). If there is no image data with a recorded date matched with the current date and time information in the calendar display table, the microcomputer 30 obtains date information of image data with the oldest recorded date in the calendar display table (S142), and determines that date as a display day (S143).

More specifically, in the case where a person operating the camera 10 is currently performing a thumbnail calendar display, if there is image date recorded (photographed) today, a thumbnail calendar of this month including today is displayed. If there is no image data recorded (photographed) today, image data with the oldest recorded date among the image data stored in the memory card is extracted, and a thumbnail calendar of a month including the recorded date is displayed.

Next, the microcomputer 30 determines a month including a display day determined in Step S143 as a display month (S144).

Next, the microcomputer 30 calculates a day of the week (S145). The day of the week can be calculated easily as a remainder obtained by dividing the number of elapsed days from a reference date stored in a memory in the microcomputer 30 by 7. The reference date is, for example, Jan. 1, 2000.

Next, the microcomputer 30 displays a calendar frame on the monitor 12 (S146). The data on the calendar frame is stored previously in a memory in the microcomputer 30. The microcomputer 30 reads the data on a calendar frame from the memory and writes the data in the image memory 31, thereby displaying the calendar frame on the monitor 12. In FIG. 24, reference numeral 193 denotes a calendar frame. The calendar frame also includes a display of days of the week.

Next, the microcomputer 30 displays a thumbnail image in the displayed calendar frame 193 (S147). Specifically, a thumbnail image is displayed on a date on which there is image data in a display month determined in Step S144. For example, in FIG. 24, a thumbnail image is displayed in an image display area 195 corresponding to Apr. 12, 2003. A position at which a thumbnail image is displayed in the calendar frame 193 can be specified based on the calculation result in Step S145. Furthermore, a thumbnail image is changed in size appropriately in accordance with the size of the image display area 195.

Next, the microcomputer 30 displays date information in the calendar frame (S148). Specifically, as shown in FIG. 24, date information 197 is displayed as a numerical value in each date frame 196. For example, in FIG. 24, “20” indicates “20th”. The date information 197 is displayed with respect to all the dates included in the display month. Furthermore, in the present embodiment, in the case where there is currently a thumbnail image with a recorded date matched with the date information (i.e., today) output by the clock controller 44, a character color of the date information 197 displayed on the thumbnail calendar is displayed in a color different from that of another date information. By changing a character color as such, when a thumbnail calendar is displayed on a screen of the monitor 12 of a camera with a relatively small size, the position of today in the calendar can be made conspicuous. Furthermore, the position of today in the thumbnail calendar may be made conspicuous by a method other than a method for changing the character color of a date. For example, a method for surrounding numerics of a date with a frame or a method for displaying a date frame in a color other than that of a cursor can be considered.

FIG. 11 shows an example of a date display. FIG. 11 shows a region corresponding to 12th in FIG. 24 in an enlarged state. In FIG. 11, in the case where there is image data whose date information (today) output from the clock controller 44 is “12th” and whose recorded date is “12th”, the character color of the date information 201 is displayed in a color different from that of another date information. Furthermore, the date information 201 is displayed so as to overlap an image 202.

Returning to FIG. 10, the microcomputer 30 displays year information, month information, and other information (S149). In FIG. 24, the year information and the month information are displayed in a year and month information area 199. Furthermore, as shown in FIG. 24, in a calendar, the cursor 143 is displayed on a date corresponding to the date information (today) output from the clock controller 44. FIG. 24 shows a position of the cursor 143 when the date information output from the clock controller 44 is “12th”.

In Step S149, although year information, month information, and a cursor are displayed, other information may be displayed in this step. For example, the operation method of the operating portion 14 may be displayed, etc.

Furthermore, although an example has been shown in which a monthly calendar is displayed in the processing of a calendar display shown in FIG. 10, the term and unit displayed on the monitor 12 can be set freely. For example, on the monitor 12, a term from January to December may be displayed with a month being a unit of a time segment, and a thumbnail of an image recorded first in that month may be displayed on a monthly basis. Furthermore, 12 hours from 8 a.m. to 8 p.m. may be classified with one hour being a unit of a time segment, and a thumbnail of an image recorded first may be displayed for each time.

As described above, the thumbnail calendar as shown in FIG. 24 can be displayed on the monitor 12.

### (3. Method for Outputting Image Data)

### (3-1. Method for Designating an Image to be Printed)

Next, a method for designating an image to be printed will be described. An image can be designated as follows. The cursor 143 displayed in a thumbnail calendar is moved to a desired date. The cursor 143 can be moved by operating the operating portion 14.

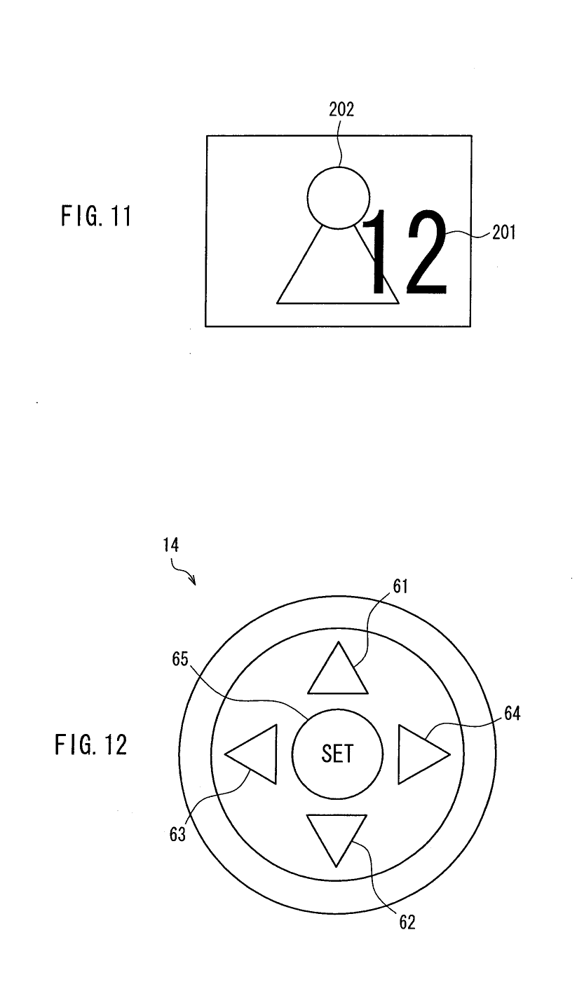

FIG. 12 shows a configuration of the operating portion 14. The cursor 143 can be moved when the operating portion 14 is operated. The operating portion 14 includes an upper key 61, a lower key 62, a left key 63, a right key 64, and a center button 65. This is a so-called cursor key with a center button. The operating portion 14 is not limited to operation keys of this type. Well-known cursor keys may be combined with one or a plurality of buttons to configure the operating portion 14.

In the present embodiment, the upper key 61 and the lower key 62 are assigned a function of selecting a month, and the left key 63 and the right key 64 are assigned with a function of selecting a date. Then, the upper key 61 and the left key 63 can perform an operation for displaying or designating a month or date in the past, and the lower key 62 and the right key 64 can perform an operation for displaying or designating a month or date in the future. Thus, the upper key 61 can perform a switching operation so as to display a thumbnail calendar of the previous month. The lower key 62 can perform a switching operation so as to display a thumbnail calendar of the next month. The left key 63 can perform an operation of moving the cursor 143 to the previous day. The right key 64 can perform an operation of moving the cursor 143 to the next day. The center button 65 is capable of switching from a thumbnail calendar display to a multi-screen display, and can perform a switching operation so as to display image data on a date on which the cursor 143 is positioned on the thumbnail calendar in a multi-screen.

As shown in FIG. 6, when a thumbnail calendar is displayed on the monitor 12 (S112), the flow becomes a key input standby state (S113). Herein, when the operating portion 14 is operated (Yes in S113), the flow proceeds to the processing (S123) based on the operation of the operating portion 14 through Steps S114, S115, and S121 shown in FIG. 7.

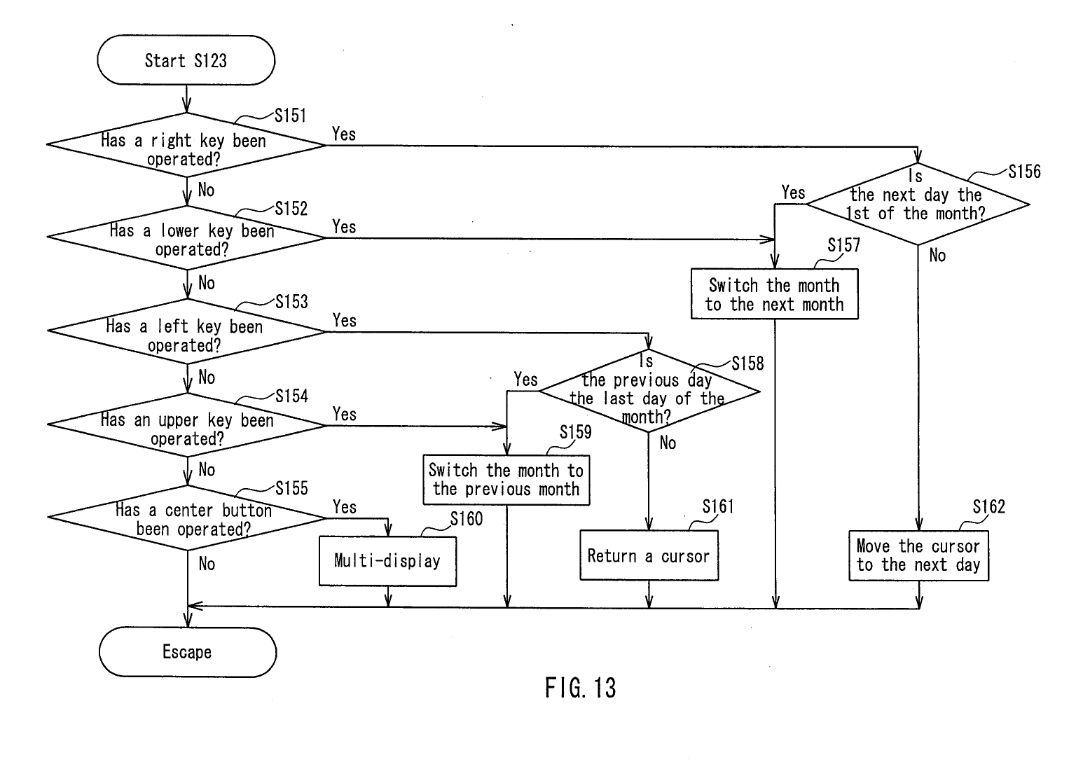

FIG. 13 shows a flow of operation processing by the operating portion 14. In FIG. 13, first, it is determined which of the right key 64 (S151), the lower key 62 (S152), the left key 63 (S153), the upper key 61 (S154), and the center button 65 (S155) the key operated in the operating portion 14 corresponds to.

In the case where the right key 64 is operated (Yes in S151), the microcomputer 30 checks whether or not the next day of a date on which the cursor 143 is currently positioned in the thumbnail calendar is a first day i.e., 1st) of the month. If the next day is not the 1st (No in S156), the microcomputer 30 moves the cursor 143 to the next day (S162). If the next day is the first day (1st) of the next month, the microcomputer 30 switches the currently displayed thumbnail calendar to the thumbnail calendar of the next month (S157).

Furthermore, in the case where the lower key 62 is operated (Yes in S152), the microcomputer 30 switches a display from the currently displayed thumbnail calendar to the thumbnail calendar of next month (S157).

Furthermore, in the case where the left key 63 is operated (Yes in S153), the microcomputer 30 checks whether or not the previous day of a date on which the cursor is currently positioned is the last day of the month on the thumbnail calendar. Herein, it cannot be determined whether or not the previous day is the last day, merely based on the date of the previous day. This is because there is a pattern of 28th, 29th, 30th, or 31st regarding the last day of the month. In this case, it is necessary to determine whether or not the previous day belongs to the previous month (S158). If the previous day does not belong to the previous month, the cursor 143 is moved to the previous day (S161). If the previous day belongs to the previous month, a display is switched from the currently displayed thumbnail calendar to the thumbnail calendar of the previous month (S159), and the cursor is moved to the last day of the previous month.

Furthermore, in the case where the upper key 61 is operated (Yes in S154), the microcomputer 30 switches a display from the currently displayed thumbnail calendar to the thumbnail calendar of the previous month (S159).

Furthermore, in the case where the center button 65 is operated (S155), the microcomputer 30 displays image data on the day on which the cursor 143 is positioned in a multi-screen (S160). Since the details of the multi-screen display are not the focus of the invention of the present application, the description thereof will be omitted.

As described above, by operating the operating portion 14, the month of the thumbnail calendar displayed on the monitor 12 is switched or the cursor 143 on the thumbnail calendar can be moved.

### (3-2. Method for Outputting Image Data)

The output of image data is started by moving the cursor 143 to a desired date and operating the print button 16 when a thumbnail calendar is being displayed.

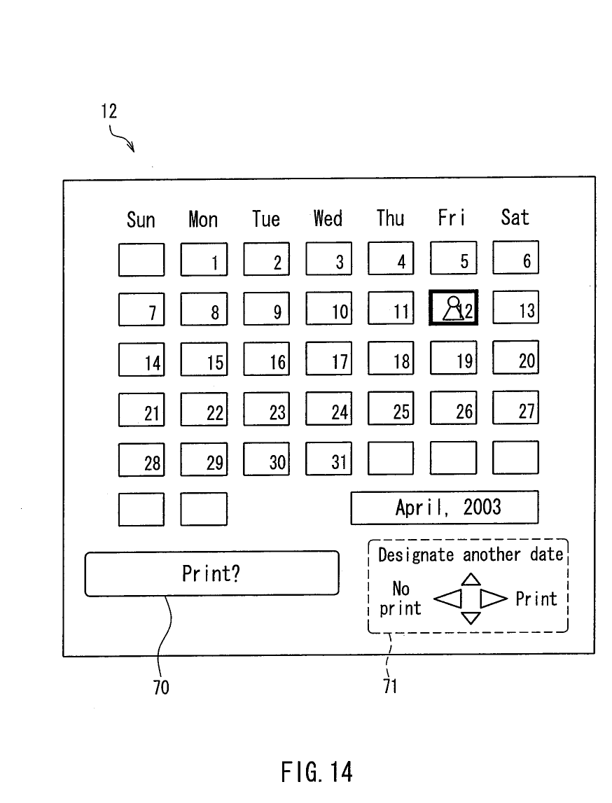

When the print button 16 is operated, the microcomputer 30 collects all the file paths of image data recorded on a designated date to create one table described later. Then, the microcomputer 30 outputs the image data of the file paths described in the table successively with a predetermined protocol. The means for outputting image data is an example of the data output portion. Furthermore, the data output portion includes software mounted on the microcomputer 30, a memory, and the external terminal 45 as constituent elements, and is operated based on the flow shown in FIG. 14.

FIG. 14 shows a screen display when the print button 16 is operated when a thumbnail calendar is being displayed. As shown in FIG. 14, a message 70 and an operation guide 71 are displayed in addition to the display of a thumbnail calendar. It is desirable that the display of the message 70 and the operation guide 71 can be controlled separately from the display control of a thumbnail calendar. A user can operate the operating portion 14 in accordance with the display of the message 70 and the operation guide 71. Herein, three choices: “Print”, “No print”, and “Designate another date” are illustrated as instructions selectable by the operating portion 14.

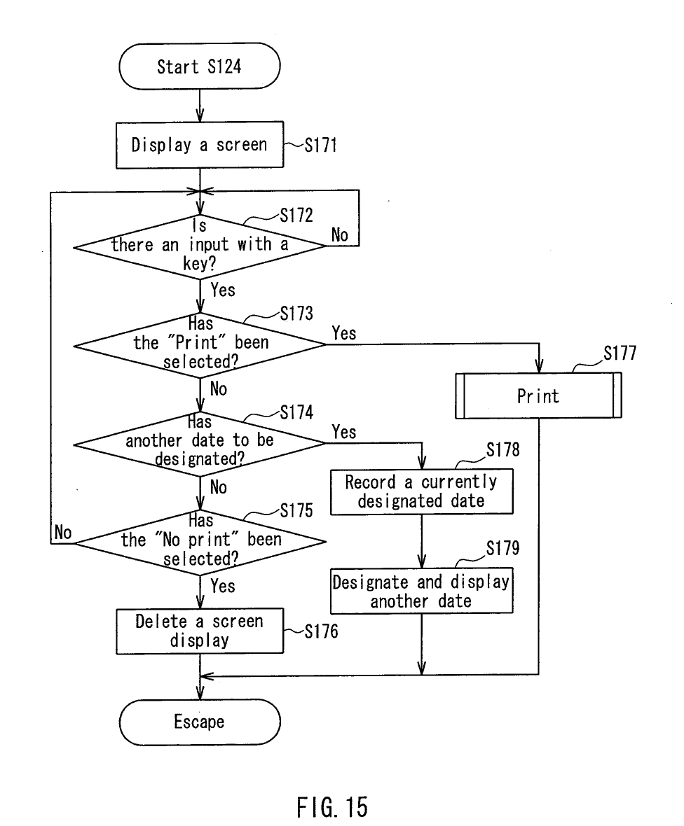

FIG. 15 shows a flow of the operation of the operating portion 14 after a print button has been operated. The flow corresponds to the processing in Step S124 in FIG. 7.

First, when the print button 16 is operated, the microcomputer 30 displays a screen shown in FIG. 14 (S171). Then, the microcomputer 30 assumes an input standby state for the operating portion 14 (S172).

In the case where the operating portion 14 is operated, and “Print” is selected (Yes in S173), the microcomputer 30 controls so as to output image data to a printer (not shown) via the external terminal 45. The printer performs printing based on a printing instruction to be input (S177).

Furthermore, in the case where the operating portion 14 is operated, and “Designate another date” is selected (Yes in S174), the microcomputer 30 stores a date currently designated by a cursor in a thumbnail calendar (S178). Next, the microcomputer 30 displays a screen capable of designating another date on the monitor 12 (S179).

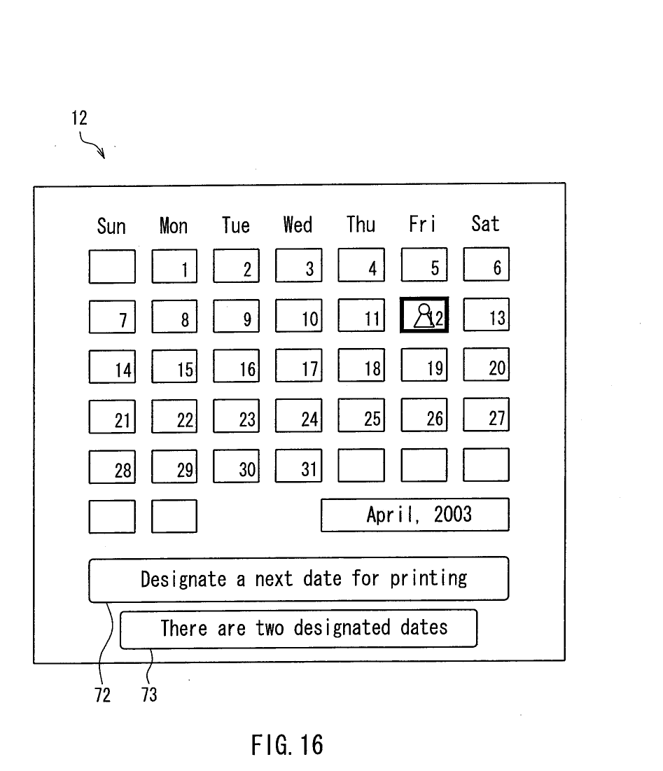

Herein, FIG. 16 shows an example of a screen for designating another date. On the screen shown in FIG. 16, a message 72 saying “please designate a next date on which printing is performed”, and a message 73 notifying the user of the number of dates designated until now. The number of days displayed in the message 73 is the number of dates stored in Step S178 in FIG. 15.

When the screen shown in FIG. 16 is displayed, and a routine shown in FIG. 15 is completed, the flow returns to Step S112 shown in FIG. 6. Therefore, the microcomputer 30 displays a thumbnail calendar again, and assumes a key-input standby state (S113). After that, the cursor 143 is moved in accordance with the above description, and the print button 16 is operated, whereby another date can be designated. At this time, until the print button 16 is operated, the messages 72 and 73 shown in FIG. 16 remain displayed, so that the user will not forget that there is a designated date to be printed. In the present embodiment, although the information on another date is recorded in a memory contained in the microcomputer 30, the information on another date may be recorded in the image memory 31 or in a memory card attached to the card slot 32.

Returning to FIG. 15, in the case where the operating portion 14 is operated, and “No print” is selected (Yes in S175), the microcomputer 30 controls so as to delete the display of the message 70 and the operation guide 71 shown in FIG. 14 and merely display a thumbnail calendar (S176).

The case of No in Step S175 corresponds to the case where undefined key or operation is performed, so that the flow returns to an input standby state (before S172) of the operating portion 14.

Furthermore, in the flow shown in FIG. 15, there is no step of deleting the display of the message 70 and the operation guide 71 after the printing (S177) is performed. This is because the processing of returning the screen to the display of only a thumbnail calendar is performed in the printing (S177).

### (3-3. Printing Operation)

Next, a printing operation indicated by Step S177 in FIG. 15 will be described.

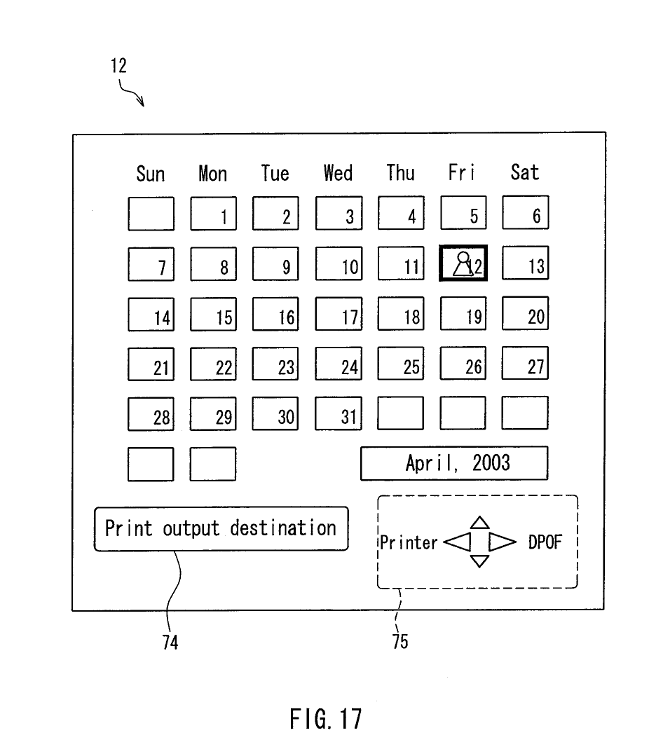

FIG. 17 shows an exemplary screen displayed in the case where a user performs an operation of printing on the screen shown in FIG. 14. Specifically, the screen shown in FIG. 17 is displayed when the right key 64 is operated when the screen in FIG. 14 is being displayed. Herein, the user selects an output form. That is, on the screen, a message 74 saying “print output destination” and an operation guide 75 of the operating portion 14 are displayed.

A plurality of formats can be output if the camera 10 stores software. FIG. 17 illustrates an output to the printer 9 and an output in a digital print order format (DPOF). The “output to the printer 9” means that image data and other data are output with a protocol in conformity with, for example, a universal serial bus (USB) specification. The protocol may be in conformity with an IEEE 1394 specification or an RS232C specification, without being limited to the USB.

The “DPOF format” is used for recording an image desired to be printed from images photographed with the camera 10 and designation information such as the number of printing in a recording medium. Thus, the data in the DPOF format is recorded in an external memory such as a memory card. The user can operate the operating portion 14, and select either one of the above-mentioned output formats.

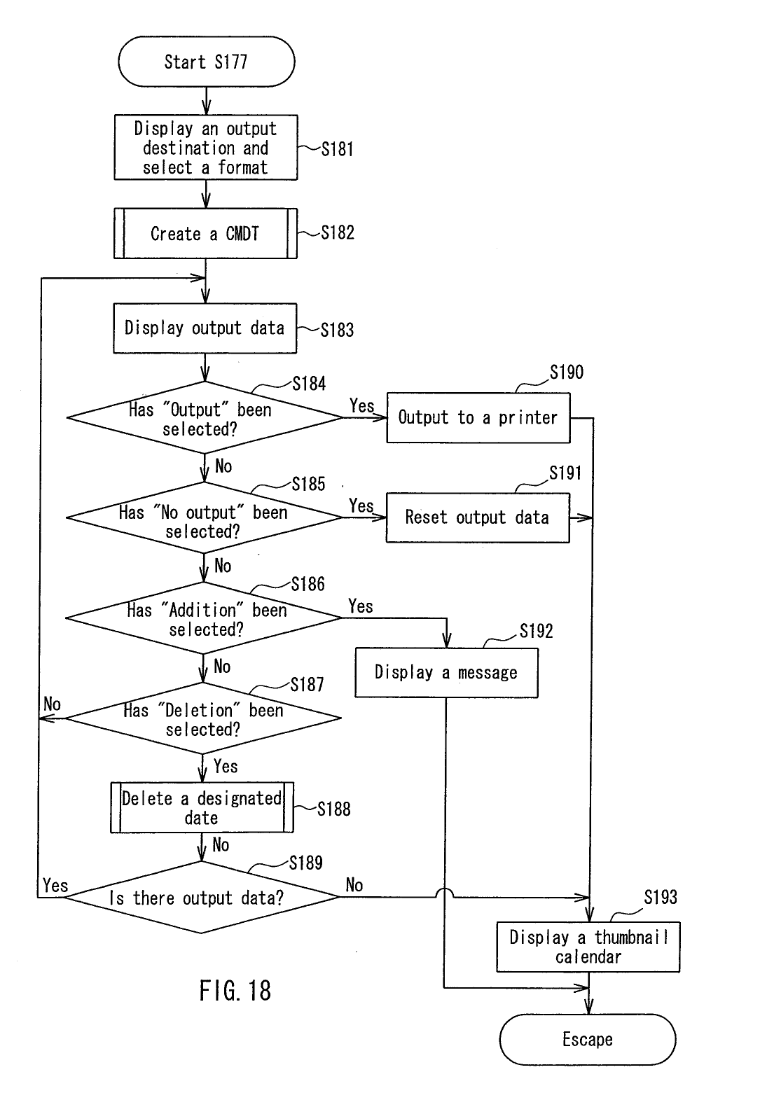

FIG. 18 is a flow showing an operation during printing. As described above, the printing is performed in Step S177 in FIG. 15.

First, the microcomputer 30 displays the screen shown in FIG. 17, and receives a selection operation of an output format (S181). Actually, herein, there is a step of a key input standby state including a key input and key determination. The step is well-known, so the description thereof is not needed. The “key input standby state” specifically refers to a standby state as indicated by S113 in FIG. 6. Furthermore, in FIG. 17, while only the option of an output format is shown, a selection button of completing a routine shown in FIG. 18 may be displayed.

The output destination of data may vary depending upon the selected output format. For example, in the case of the present embodiment, as described with reference to FIG. 17, the output to the printer 9 and the output in a DPOF format are illustrated. In the case of the output to the printer 9, data is output to the external terminal 45 shown in FIG. 2. Furthermore, in the case of the output in the DPOF format, data is output to the card slot 32. These output destinations are selected by the microcomputer 30.

Next, as shown in FIG. 18, the microcomputer 30 creates a multi-screen display table for a calendar (hereinafter, referred to as a “CMDT”) (S182). The CMDT is a table storing file paths of all the image data recorded on a designated date and is created in a memory contained in the microcomputer 30 in FIG. 2. Originally, the CMDT is a table that is created when images on a date designated with the cursor 143 are displayed in a multi-screen when a thumbnail calendar is being displayed, and also can be used for a print output.

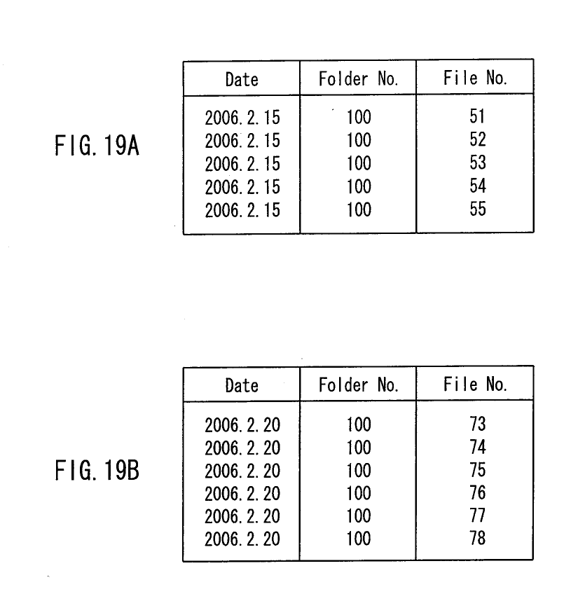

FIGS. 19A and 19B show examples of the CMDT. In the CMDT, all the folder numbers and file numbers recorded on a designated date are collected. For example, FIG. 19A shows that 5 image data of file numbers “51” to “55” are recorded in a folder of a folder number “100” with a recorded date “Feb. 15, 2006” in a memory card. The files shown in FIG. 19A are recorded on the same day, so that the file numbers are serial numbers. However, the file numbers may not be serial numbers.

Furthermore, a plurality of CMDTs may be created. FIG. 19B shows a CMDT with a recorded date of “Feb. 20, 2006”. It is understood that there are 6 images corresponding to the CMDT shown in FIG. 19B. The detailed configuration of the CMDT will be described later.

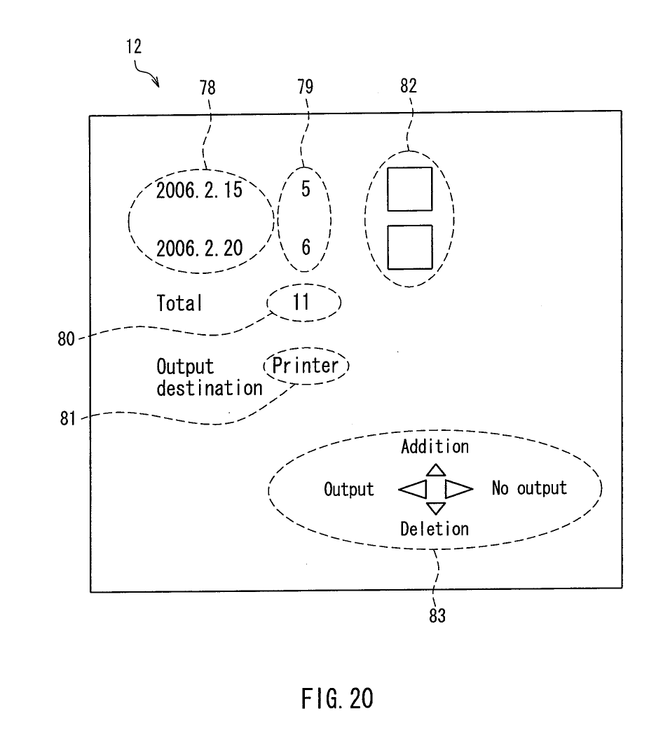

Next, as shown in FIG. 18, the microcomputer 30 displays information on image data to be output on the monitor 12 (S183). FIG. 20 shows a state in which information on the image data to be output is displayed. On the screen shown in FIG. 20, at least designated date information 78 (designated dates) and number information 79 on the number of images corresponding to the dates are displayed. The user can check the dates (designated dates) designated for printing and the number of images recorded on the designated dates to be output by watching the screen displayed as shown in FIG. 20. The date information 78 and the number information 79 are created based on the CMDT created in Step S182. Thus, in the case where there are a plurality of designated dates, the date information 78 and the number information 79 are displayed as shown in FIG. 20 even regarding other dates. The example in FIG. 20 show that Feb. 15, 2006 and Feb. 20, 2006 are designated.

The date information 78 constitutes a part of attached data, and is output together with pixel data. Examples of the attached data include dates, photographing conditions, a photographed place, and a user name. Furthermore, conditions regarding whether or not attached data is printed on photographic paper during printing may be designated.

Furthermore, as shown in FIG. 20, total number information 80 on images to be output, output destination information 81, and thumbnail images 82 can be displayed. The thumbnail images 82 are those displayed when a thumbnail calendar is being displayed.

Furthermore, if the operation guide 83 showing an operation procedure from the screen shown in FIG. 20 is displayed, the operability can be enhanced. In the example shown in FIG. 20, as the selection by the operating portion 14, four instructions: “Output”, “Non-output”, “Addition”, and “Deletion” are shown. The “Addition” means that a designated date is added. The “Deletion” means that a displayed designated date is deleted. By operating the left key 63, the right key 64, the upper key 61, or the lower key 62 shown in FIG. 12, each of the above instructions can be input.

Furthermore, the screen shown in FIG. 20 may be displayed after the display of a thumbnail calendar is erased completely. The screen shown in FIG. 20 and the screen shown in FIG. 24 may be displayed so as to overlap each other in a semi-transparent display.

Furthermore, Step S183 includes a routine in a key input standby state. The routine in a key input standby state refers to a standby state as indicated by S113 in FIG. 6.

Next, as shown in FIG. 18, in the case where the operating portion 14 is operated, and the “Output” is selected (Yes in S184), the microcomputer 30 converts image data and attached data into a predetermined protocol and outputs them to the external terminal 45 or the card slot 32 (S190). The microcomputer 30 obtains image data from a memory card based on a file path of the image data shown in FIG. 19, converts the obtained image data into a predetermined protocol, and outputs the image data to a predetermined output terminal. In the present embodiment, the microcomputer 30 outputs the image data to the printer 9. The output processing of image data is performed successively with respect to all the file paths of image data recorded in the CMDT. When the output of image data is completed, a thumbnail calendar is displayed on the monitor 12 (S193), and the routine is completed.

Furthermore, in the case where the operating portion 14 is operated, and the “Non-output” is selected (Yes in S185), the microcomputer 30 resets data to be output (S191). Next, a thumbnail calendar is displayed on the monitor 12 (S193), and the routine is completed. The data may be reset by erasing the CMDT shown in FIG. 19.

Furthermore, in the case where the operating portion 14 is operated, and the “Addition” is selected (S186), the microcomputer 30 displays the message 70 and the operation guide 71 as shown in FIG. 14 (S192), and completes the routine. When the display shown in FIG. 14 is performed and the routine shown in FIG. 18 is completed, the flow returns to the key input standby state shown in FIG. 6 (S113). More specifically, the movement of a cursor and the operation of designating a date can be repeated again.

As shown in FIG. 18, in the case where the operating portion 14 is operated and the “Deletion” is selected (Yes in S187), the microcomputer 30 deletes a designated date (S188).

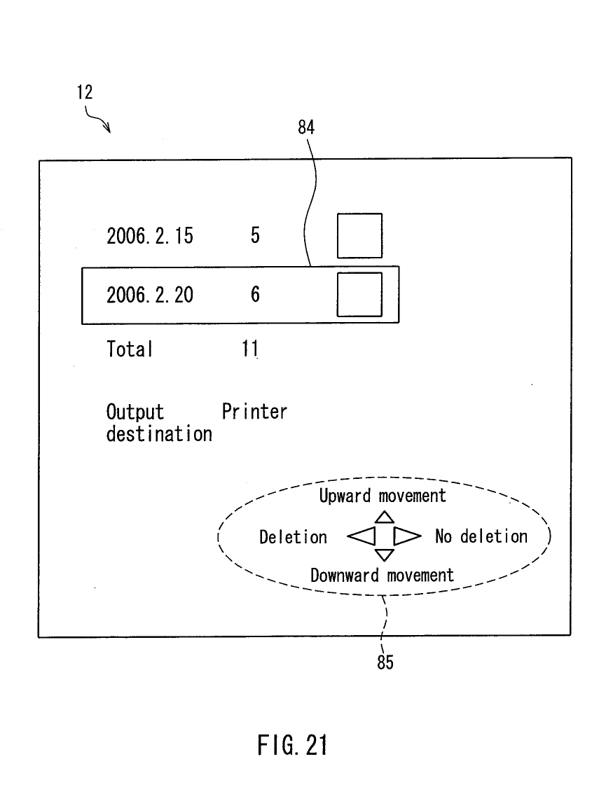

FIG. 21 shows an exemplary screen for deleting a designated date. As shown in FIG. 21, the cursor 84 can be moved to any of the designated dates displayed on the monitor 12. The operation guide 85 of the operating portion 14 is displayed on the monitor 12. In the configuration shown in FIG. 21, the cursor 84 can be moved in an upward direction or a downward direction by operating the upper key 61 or the lower key 62 (see FIG. 12) of the operating portion 14. Furthermore, it can be selected whether or not the designated date is deleted by operating the left key 63 or the right key 64 of the operating portion 14 (see FIG. 12). The CMDT designated with the cursor 84 can be deleted by operating the left key 63 or the right key 64 of the operating portion 14 to operate “Deletion”. The detail of the processing will be described later.

Next, as shown in FIG. 18, after deleting the CMDT (S188), the microcomputer 30 determines whether or not there is output data (S189). In the case where all the CMDTs are deleted and there is no data to be output, the microcomputer 30 displays a thumbnail calendar (S193) and completes the routine.

On the other hand, in the case where there is data to be output (Yes in S189), the flow returns to Step S183. Image data having recording information on a designated date is output successively under the condition that a thumbnail calendar is being displayed as described above. Therefore, images can be printed in one operation for each recorded date (each designated date) without the necessity of checking images one by one.

### (3-4. Method for Creating a CMDT)

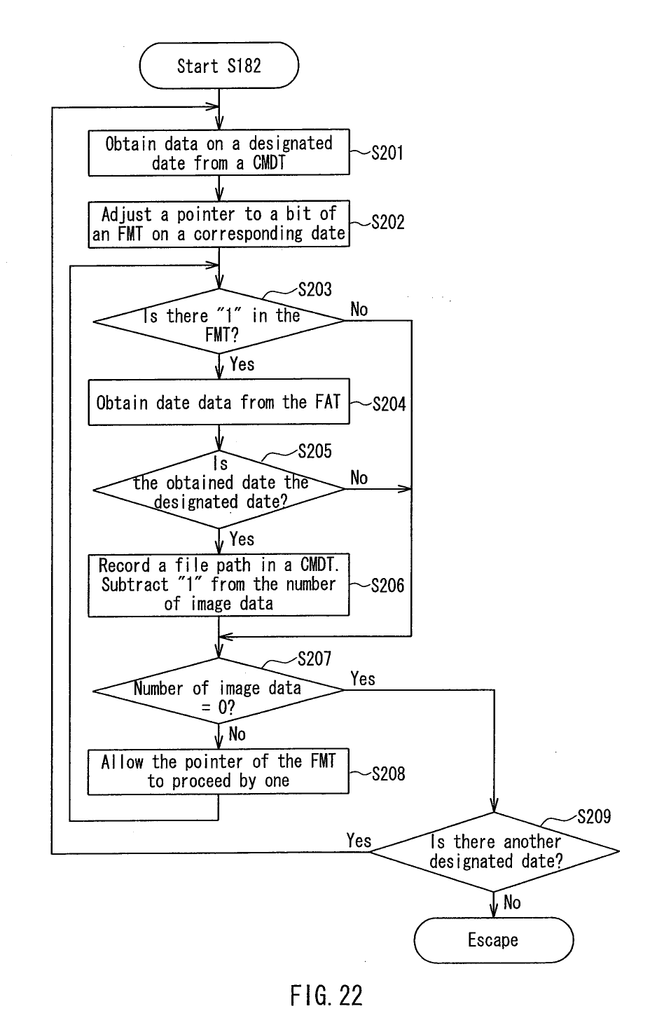

FIG. 22 shows a flow of creating a CMDT. The flow shown in FIG. 22 is performed in Step S182 in FIG. 18.

First, the microcomputer 30 obtains a folder number, a file number, and number information of a designated date from the calendar display table shown in FIG. 8 (S201).

Next, the microcomputer 30 adjusts a pointer to a bit of the file management table (see FIG. 5) corresponding to the designated date (S202). After that, a file path of the designated date is searched for while the pointer is allowed to proceed.

Next, the microcomputer 30 checks whether or not the value of a bit at which the pointer is positioned is “1” (S203). The value of the bit being “1” indicates that there is a file containing image data. When Step S203 is performed initially, a file path of image data on the designated date is designated to set a pointer, so that the value of the bit is “1” without fail.

Then, if there is a file, the microcomputer 30 obtains information on a recorded date from an FAT in the memory card.

Next, the microcomputer 30 determines whether or not the recorded date obtained form the FAT is matched with the designated date (S205). If the recorded date is matched with the designated date, the microcomputer 30 records a file path of the image data in the CMDT, and subtracts “1” from the number information (S206).

Next, the microcomputer 30 checks the number information. When the number information is “1” or more, the microcomputer 30 allows the pointer to proceed by one (S208), and the flow returns to Step S203. After that, the processing in Steps S203-S208 is performed until the number information becomes “0”. When the number information becomes “0” (Yes in S207), the microcomputer 30 completes the search.

In the case where there is no file on the designated date, i.e., in the case where the value of the corresponding bit in the file management table is “0” (No in S203), the flow proceeds to Step S207 and the search is continued. Furthermore, in the case where the obtained date is not matched with the designated date as the result of the check of the FAT (No in S205) even if the value of the bit in the file management table is “1” (Yes in S203), a file path is not recorded in the CMDT, and the flow is allowed to proceed to Step S207. The number information becoming “0” means that the information on image data on the designated date is all recorded in the CMDT.

Next, the microcomputer 30 checks whether or not another designated date is set (S209). If another designated date is not set, the microcomputer 30 completes the routine. If another designated date is set, the flow returns to Step S201.

Since the calendar display table is created in accordance with the flow in FIG. 9, image data associated with the smallest file path and number information are recorded in the calendar display table. Thus, by subtracting “1” from the number information every time a designated date is found in the FAT as described above, all the corresponding image data can be searched for. Furthermore, it is not necessary to search for a file path smaller than that described in the calendar display table.

### (3-5. Method for Deleting Output Data)

Next, a method for deleting output data (S188 in FIG. 18) will be described.

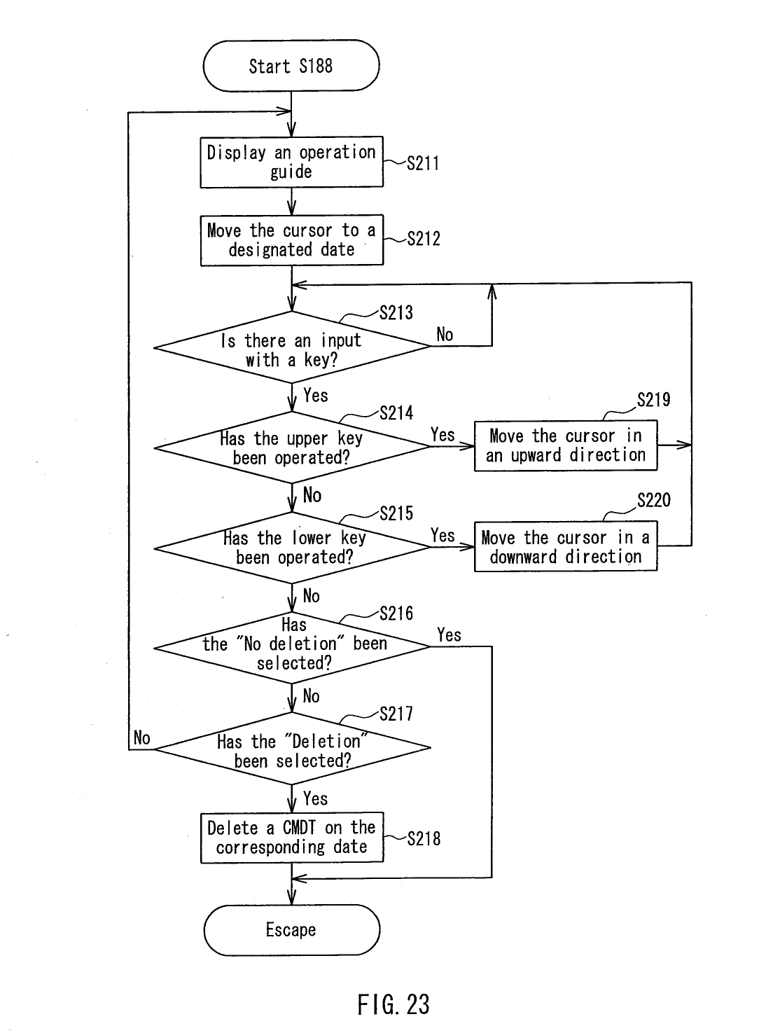

FIG. 23 is a flowchart showing a flow of deleting output data. First, as shown in FIG. 21, the microcomputer 30 displays the operation guide 85 on the monitor 12 (S211). Next, as shown in FIG.21, the microcomputer 30 moves the cursor 84 to a designated date displayed on the monitor 12 (S212).

Herein, the purpose of the cursor 84 is to indicate the designated date to be deleted. Therefore, a display method for indicating a designated date with an arrow or an asterisk may be used instead of the cursor 84. Furthermore, a display method for making the character color of the currently indicated designated date different from that of other designated dates may be used. More specifically, any method may be used as long as the difference between the currently indicated designated date and the other designated dates can be clarified.

Next, the microcomputer 30 assumes a key input standby state (S213). As shown in the operation guide 85 in FIG.21, the upper key 61 or the lower key 62 (see FIG. 12) of the operating portion 14 is operated, whereby the cursor 84 can be moved in an upward direction or a downward direction. Furthermore, an instruction can be given as to whether or not the designated date indicated by the cursor 84 is deleted by operating the left key 63 or the right key 64 (see FIG. 12).

Next, when the upper key 61 is operated (S214), the microcomputer 30 moves the cursor 84 in an upward direction on the screen of the monitor 12 shown in FIG. 21 (S219). Furthermore, when the lower key 62 is operated (S215), the microcomputer 30 moves the cursor 84 in a downward direction on the screen of the monitor 12 shown in FIG. 21 (S220). Herein, if a designated date is not displayed on the upper side of the designated date currently indicated by the cursor 84, the cursor 84 may be moved to a designated date displayed in an undermost portion. More specifically, the cursor 84 movably may be displayed in a circulation manner.

Furthermore, when the right key 64 is operated, and the “No Deletion” is selected (S216), the microcomputer 30 completes the routine shown in FIG. 23.

Furthermore, in the case where the left key 63 is operated, and the “Deletion” is selected (S217), the microcomputer 30 erases the CMDT corresponding to the designated date indicated by the cursor 84 (S218). Specifically, the CMDT (see FIG. 19) stored in a memory in the microcomputer 30 (see FIG. 2) is erased. When the deletion processing is completed, the routine in FIG. 23 is completed.

### (4. Effects of an Embodiment, etc.)

According to the present embodiment, a printing instruction or printing setting can be performed by specifying either one of segments listed for each time segment (designated date). Therefore, a list display can be associated with a printing instruction or printing setting directly. Therefore, a user who viewed a list display can perform a printing instruction or printing setting immediately, so that the operability can be enhanced.

Furthermore, the image data is classified based on a photographed date and time or a recorded date and time, that is, the image data can be classified based on the information familiar to the user such as a photographed date and time and the recorded date and time. Therefore, the user is likely to understand which images are contained in each classification, so that the convenience can be enhanced.

Furthermore, a thumbnail image is displayed on a calendar displayed on the monitor 12, whereby the user is likely to grasp visually which images are classified in each time segment.

Furthermore, due to the presence of the external terminal 45, an image for which a printing instruction has been given under the condition of a list display can be output to an external appliance immediately.

Furthermore, the external terminal 45 may be adapted to a plurality of different output protocols, and the microcomputer 30 may select which of the plurality of output protocols is used to output image data to the external appliance. Because of this, among the plurality of output protocols, an optimum protocol is selected at each time, and the image data can be output.

Furthermore, the monitor 12 may display printing contents set in accordance with the operation received by the operating portion 14. This enables the user to check the printing contents once set.

Furthermore, the microcomputer 30 is configured so as to create a CMDT. Thus, when a printing instruction or the like is entered while a thumbnail calendar is being displayed, the external appliance (printer) can be given an instruction at a high speed.

A camera capable of photographing is provided with a printing control apparatus, whereby a camera with high convenience can be realized.

In the present embodiment, although an example in which image data is classified for each predetermined time segment has been illustrated, the present invention is not limited thereto. For example, the image data may be classified for each photographed place. In this case, the monitor 12 may display photographed place segments in a list, and display thumbnail images corresponding to each photographing place segment. Herein, regarding the information representing a photographed place, the user may input address information by operating the operating portion 14 or a global positioning system (GPS) may be mounted on a camera so that positional information is obtained from a satellite

The image data may be classified, for example, for each camera having photographed. In this case, the monitor 12 displays information (machine type, etc.) on the cameras having photographed in a list. In the case of a list display for each camera, a representative thumbnail image may be displayed for each camera.

Furthermore, the image data may be classified for, for example, each photographing condition such as a shutter speed.

In the case where a camera is of a lens exchange type, the image data also may be classified for each machine type of an exchange lens.

Furthermore, a medium capable of storing an image photographed with the camera 10 is not limited to a memory card with a semiconductor memory as in the present embodiment, and may be a medium capable of at least recording digital data.

The memory in the microcomputer 30, the image memory 31, or the memory card is an example of a storage portion.

The present invention can be applied to an apparatus that classifies images and displays them in a list. For example, the present invention is applicable to a digital still camera, a video camera, and a mobile telephone terminal with a camera function.

### (Note 1)

A printing control apparatus of the present invention reading electronic image information recorded in a storage and giving a printing instruction with respect to a whole or a part of the read electronic image information, includes: a display that displays predetermined time segments in a list; a controller that classifies the electronic image information recorded in the storage for each of the predetermined time segments; and an operating portion that receives a predetermined operation and transmits a content of the received operation to the controller, wherein when the operating portion receives a predetermined operation for printing including an operation for specifying one or a plurality of time segments among the predetermined time segments displayed in a list, the controller controls so as to give a printing instruction with respect to a whole or a part of the electronic image information classified in time segment(s) specified by the predetermined operation or perform setting with respect to the printing.

According to the above configuration, any of the segments displayed in a list for each time segment is specified, whereby a printing instruction or printing setting can be performed. Therefore, a list display can be associated with a printing instruction or printing setting directly. Therefore, a user who has seen a list display can give a printing instruction or set printing immediately, so that the operability can be enhanced.

Pixel data, image data containing pixel data, or an image file are an example of the electronic image information. The memory in the microcomputer 30, the image memory 31, or the memory card is an example of the storage. Furthermore, the monitor 12 is an example of the display. The microcomputer 30 is an example of the controller. Furthermore, the operating portion 14 composed of cursor keys is an example of an operating portion.

### (Note 2)

In the printing control apparatus of the present invention, the controller may classify the electronic image information recorded in the storage for each time segment representing a photographed date and time or a recorded date and time with respect to the storage of the electronic image information.

According to the above configuration, the electronic image information can be classified based on the information familiar to the user such as a photographed date and time or a recorded date and time. Therefore, the user is likely to understand which images are contained in each classification, and the convenience can be enhanced.

The photographed date and time, photographed date, recorded date and time, or recorded date is an example of the time segment.

### (Note 3)

In the printing control apparatus of the present invention, the display may display thumbnail images corresponding to any of the electronic image information classified in the predetermined time segments in the list.

According to the above configuration, representative images of the electronic image information classified in each time segment are displayed in a list. Therefore, it is easy to grasp visually which images are classified in each time segment.

A thumbnail calendar is an example of a list display.

### (Note 4)

The printing control apparatus of the present invention further may include a data output portion that outputs electronic image information whose printing instruction is given by the controller to an external appliance.

According to the above configuration, an image whose printing instruction is given from a list can be output to an external appliance immediately, whereby the operability can be enhanced.

The printer 9 is an example of the external appliance. The external terminal 45 is an example of the data output portion.

### (Note 5)

In the printing control apparatus of the present invention, the data output portion is adapted to a plurality of different output protocols, and the controller may select any of the plurality of output protocols when the electronic image information is output to the external appliance.

According to the above configuration, an optimum protocol can be selected to be output each time from the plurality of output protocols.

### (Note 6)

The printing control apparatus of the present invention further includes a clock controller, wherein the display displays the same time segment as that of date and time information output by the clock controller in the list in an embodiment different from another time segment. In this case, the display may display a mark in the same time segment as the date and time indicated by the clock controller in the list.

The clock controller 44 is an example of the clock controller.

### (Note 7)

In the printing control apparatus of the present invention, the display may display a printing content set in accordance with an operation received by the operating portion.

According to the above configuration, the user can identify the once set printing content visually.

### (Note 8)

In the printing control apparatus of the present invention, the controller may create a table containing location information in the storage of the electronic image information classified in the time segment specified in the operating portion.

According to the above configuration, processing such as a printing instruction can be performed at a high speed.

A multi-image display table (CMDT) for a calendar is an example of a table containing location information.

### (Note 9)

An image pickup apparatus of the present invention reading electronic image information recorded in a storage and giving a printing instruction with respect to a whole or a part of the read electronic image information, includes: a display that displays predetermined time segments in a list; a controller that classifies the electronic image information recorded in the storage for each of the predetermined time segments; and an operating portion that receives a predetermined operation and transmits a content of the received operation to the controller, wherein when the operating portion receives a predetermined operation for printing including an operation for specifying one or a plurality of time segments among the predetermined time segments displayed in a list, the controller controls so as to give a printing instruction with respect to a whole or a part of the electronic image information classified in a time segment specified by the predetermined operation or perform setting with respect to the printing.

According to the above configuration, an image pickup apparatus with high convenience can be provided.

The invention may be embodied in other forms without departing from the spirit or essential characteristics thereof The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A printing control apparatus reading electronic image information recorded in a storage and giving a printing instruction with respect to a whole or a part of the read electronic image information, comprising:
a display that displays predetermined time segments in a list;
a controller that classifies the electronic image information recorded in the storage for each of the predetermined time segments; and
an operating portion that receives a predetermined operation and transmits a content of the received operation to the controller,
wherein when the operating portion receives a predetermined operation for printing including an operation for specifying one or a plurality of time segments among the predetermined time segments displayed in a list, the controller controls so as to give a printing instruction with respect to a whole or a part of the electronic image information classified in a time segment specified by the predetermined operation or perform setting with respect to the printing.

2. The printing control apparatus according to claim 1, wherein the controller classifies the electronic image information recorded in the storage for each time segment representing a photographed date and time of the electronic image information or a recorded date and time with respect to the storage.

3. The printing control apparatus according to claim 1, wherein the display displays thumbnail images corresponding to any of the electronic image information classified in the predetermined time segments in the list.

4. The printing control apparatus according to claim 1, further comprising a data output portion that outputs electronic image information whose printing instruction is given by the controller to an external appliance.

5. The printing control apparatus according to claim 4, wherein the data output portion is adapted to a plurality of different output protocols, and the controller is capable of selecting any of the plurality of output protocols when the electronic image information is output to the external appliance.

6. The printing control apparatus according to claim 1, further comprising a clock controller, wherein the display displays the same time segment as that of date and time information output by the clock controller in the list in an embodiment different from another time segment.

7. The printing control apparatus according to claim 1, wherein the display displays a printing content set in accordance with an operation received by the operating portion.

8. The printing control apparatus according to claim 1, wherein the controller creates a table containing location information in the storage of the electronic image information classified in the time segment specified in the operating portion.

9. An image pickup apparatus reading electronic image information recorded in a storage and giving a printing instruction with respect to a whole or a part of the read electronic image information, comprising:
a display that displays predetermined time segments in a list;
a controller that classifies the electronic image information recorded in the storage for each of the predetermined time segments; and
an operating portion that receives a predetermined operation and transmits a content of the received operation to the controller,
wherein when the operating portion receives a predetermined operation for printing including an operation for specifying one or a plurality of time segments among the predetermined time segments displayed in a list, the controller controls so as to give a printing instruction with respect to a whole or a part of the electronic image information classified in a time segment specified by the predetermined operation or perform setting with respect to the printing.
